(19) United States
(12) Patent Application Publication
(10) Pub. No.: US 2019/0063626 A1
(43) Pub. Date: Feb. 28, 2019

(54) MESH VALVE PROTECTION DEVICE

(71) Applicant: Zahroof Valves Inc., Houston, TX (US)

(72) Inventor: Zahroof Mohamed, Cypress, TX (US)

(21) Appl. No.: 16/107,413

(22) Filed: Aug. 21, 2018

Related U.S. Application Data
(60) Provisional application No. 62/548,415, filed on Aug. 22, 2017.

(51) Int. Cl. F16K 13/00

(52) U.S. Cl. CPC F16K 13/00

(57) ABSTRACT

A mesh valve protection device includes at least one layer of mesh, wherein the mesh valve protection device is adapted to be positioned proximate an inlet of a valve assembly so that a fluid flow controlled by the valve assembly passes through the at least one layer of mesh of the mesh valve protection device before passing through the valve assembly.

### BACKGROUND

### 1. Field of the Disclosure

Generally, the present disclosure relates to compressor valves, and, more specifically, to mesh devices that can be used to protect valves from the presence of liquids or solids in the gas stream.

### 2. Description of the Related Art

As will be appreciated, fluids, such as natural gas, hydrogen, process gases, refrigerants and air, have a wide array of uses in industrial and commercial applications. For example, natural gas may be used to provide power to a range of vehicles, to heat buildings during winter, and to operate various consumer appliances, such as ovens or clothes dryers. Furthermore, natural gas may be used to generate electricity for distribution over a power grid, and different process gases and air may be used in the manufacture of an array of products and materials, including glass, steel, and/or plastics and the like.

In order to meet the demand for natural gas, companies may spend a significant amount of time and resources searching for, extracting, and transporting natural gas. Additionally, hydrogen may be produced centrally and distributed through pipelines. In process plants, different gases or liquids are transported through passageways to locations where it may be required. In most large factories, air under pressure is made available at different points through a network of pipes. As may also be appreciated, transportation of such gases or liquids, such as through a pipeline from one point to another, is often facilitated by compression of the gas or liquid via a compressor or pump.

One common type of compressor for such applications is a reciprocating compressor. Such reciprocating compressors are positive-displacement devices that generally utilize a crankshaft that is coupled to pistons, via connecting rods and crossheads, to reciprocally drive the pistons and compress a fluid within attached compression cylinders. As may be appreciated by one skilled in the art, gas is generally introduced into compression chambers of the cylinders through one or more inlet or suction valve assemblies and, following compression, the fluid generally exits the cylinders via one or more outlet or discharge valve assemblies.

As many compressors routinely operate at hundreds or thousands of rotations per minute (rpm), with the pressure in the cylinder cycling from a low suction pressure to the high discharge pressure, the valve sealing elements are also opened and closed at a similarly high rate. Due to this rapid cycling, the seat plate, the guard, and/or the sealing elements are subject to high stresses, and are carefully designed so as to have a reasonable life under the anticipated operating parameters. Such operating parameters include, among other things, the type and quality of the gas, the speed of the compressor, the geometry of the compressor, the suction temperature and pressure, and the discharge pressure.

Gas compressor valves are designed specifically for gases. However, in some applications, there is a possibility that liquids and/or solid particles might flow along with the gas stream into the valves. These slugs of liquids, or solid particles, have a density and momentum that is much higher than the gas that the valve is designed for, and as such can sometimes cause damage to the valves. Some valves may have a higher tolerance to liquids and solids in the gas stream than other valves, however if the liquid slugs or solids are large enough, all compressor valves may be subject to failure.

To prevent liquids and solids from entering the compressor, devices such as filters, screens, separators and/or scrubbers may be used in the compressor package. However, there are certain cases where the liquids and/or solids enter the gas stream downstream of such devices, and can therefore flow through a valve and damage one or more of the valve's components. For example, in some instances, liquids may be formed because heavier gases drop out at high pressure after being cooled in an intercooler, or scale and/or debris may be picked up from the piping downstream of these devices. Furthermore, in the case of natural gas, hydrates can form at points of high pressure and low temperature, or liquids/hydrates can form when side streams of gas are introduced in a down-stream stage. If the liquid slugs or solid particles are big enough, or are travelling with a sufficiently high velocity, they will damage any valve that they encounter.

When a valve is damaged, the compressor performance is affected, resulting in lower flow rates, higher power consumption, or the compressor may not be able to make the required pressure. Under such circumstances, the compressor typically must be shut down and the valves repaired. However, it should be appreciated that shutting down the compressor will lead directly to lost production and subsequent revenue. Furthermore, repairing compressor valves can be expensive. As such, compressor operators and valve manufacturers are constantly seeking solutions for avoiding the problem of compressor valve damage caused by liquids or solids that may be present within the gas stream.

The present disclosure is directed to various new and unique devices that may be used to reduce, or even substantially eliminate, the damage that can occur to compressor valves when liquids and/or solids are entrained within a gas stream flowing through a compressor.

### SUMMARY OF THE DISCLOSURE

The following presents a simplified summary of the disclosure in order to provide a basic understanding of some aspects of the subject matter that is described in further detail below. This summary is not an exhaustive overview of the disclosure, nor is it intended to identify key or critical elements of the subject matter disclosed here. Its sole purpose is to present some concepts in a simplified form as a prelude to the more detailed description that is discussed later.

Generally, the subject matter disclosed herein is directed to various new and unique mesh valve protection devices that may protect the valve from damage caused by liquids and/or solids that may be entrained in a gas stream flowing to the valve. In one exemplary embodiment disclosed herein, a mesh valve protection device includes at least one layer of mesh, wherein the mesh valve protection device is adapted to be positioned proximate an inlet of a valve assembly so that a fluid flow controlled by the valve assembly passes through the at least one layer of mesh of the mesh valve protection device before passing through the valve assembly.

In another illustrative embodiment, a valve assembly is disclosed that includes, among other things, a valve and mesh valve protection device that includes at least one layer of mesh, wherein the mesh valve protection device is positioned proximate an inlet of the valve so that a fluid flow controlled by the valve passes through the at least one layer of mesh before passing through the valve.

Also disclosed herein is an exemplary method of protecting a valve assembly during operation that includes providing a valve assembly and positioning a mesh valve protection device proximate an inlet of the valve assembly, the mesh valve protection device including at least one layer of mesh. The illustrative method further includes controlling a fluid flow with the valve assembly, wherein the fluid flow passes through the at least one layer of mesh of the mesh valve protection device prior to flowing through the valve assembly.

### BRIEF DESCRIPTION OF THE DRAWINGS

The disclosure may be understood by reference to the following description taken in conjunction with the accompanying drawings, in which like reference numerals identify like elements, and in which:

FIG. 1 is a perspective view of an illustrative reciprocating compressor that includes an exemplary valve assembly in accordance with one embodiment of the present disclosure;

FIG. 2 is an axial cross-sectional view of the exemplary reciprocating compressor of FIG. 1, depicting internal components of the compressor in accordance with an illustrative embodiment disclosed herein;

FIG. 3 is a perspective view of an exemplary compressor valve having an integral cage;

FIG. 4 is a cross-sectional view of an exemplary mesh when viewed along the section line “4-4” of FIGS. 5-7 in accordance with one illustrative embodiment disclosed herein;

FIG. 5 is an exploded perspective view of the integral cage valve illustrated in FIG. 3 that includes an exemplary mesh valve protection device that is substantially in the shape of a cylinder in accordance with some illustrative embodiments of the present disclosure;

FIG. 6 is an exploded perspective view of the integral cage valve shown in FIG. 3 that includes another illustrative mesh valve protection device that is substantially in the shape of a truncated cone in accordance with certain exemplary aspects disclosed herein; and

FIG. 7 is an exploded perspective view of the integral cage valve depicted in FIG. 3 that includes a further exemplary mesh valve protection device having a substantially flat shape according to further illustrative embodiments of the present disclosure.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the subject matter defined by the appended claims to the particular forms disclosed, but on the contrary, the intention is to cover all modifications, equivalents, and alternatives falling within the spirit and scope of the claimed subject matter.

### DETAILED DESCRIPTION

Various illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various systems, structures and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As used in this description and in the appended claims, the terms “substantial” or “substantially” are intended to conform to the ordinary dictionary definition of that term, meaning “largely but not wholly that which is specified.” As such, no geometrical or mathematical precision is intended by the use of terms such as “substantially flat,” “substantially perpendicular,” “substantially parallel,” “substantially circular,” “substantially elliptical,” “substantially rectangular,” “substantially square,” “substantially aligned,” and/or “substantially flush,” and the like. Instead, the terms “substantial” or “substantially” are used in the sense that the described or claimed component or surface configuration, position, or orientation is intended to be manufactured, positioned, or oriented in such a configuration as a target. For example, the terms “substantial” or “substantially” should be interpreted to include components and surfaces that are manufactured, positioned, or oriented as close as is reasonably and customarily practicable within normally accepted tolerances for components of the type that are described and/or claimed. Furthermore, the use of phrases such as “substantially conform” or “substantially conforms” when describing the configuration or shape of a particular component or surface, such as by stating that “the configuration of the component substantially conforms to the configuration of a rectangular prism,” should be interpreted in similar fashion.

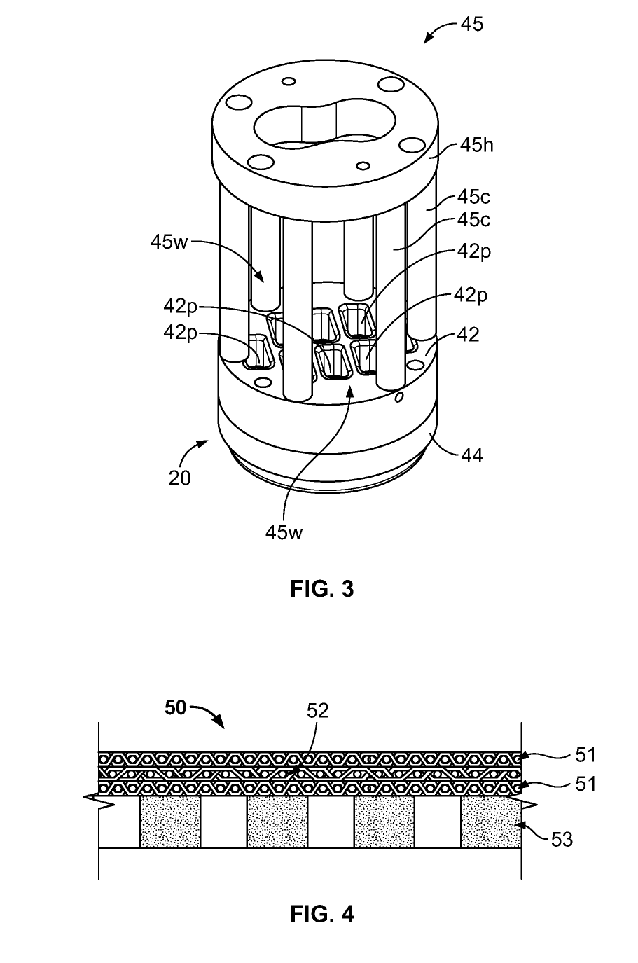

Furthermore, it should be understood that, unless otherwise specifically indicated, any relative positional or directional terms that may be used in the descriptions set forth below—such as “upper,” “lower,” “above,” “below,” “over,” “under,” “top,” “bottom,” “vertical,” “horizontal,” “lateral,” and the like—have been included so as to provide additional clarity to the description, and should be construed in light of that term's normal and everyday meaning relative to the depiction of the components or elements in the referenced figures. For example, referring to the perspective view of the integral caged valve assembly depicted in FIG. 3, it should be understood that the valve cage 45 is shown as being positioned “above” the valve assembly 20, and the carrier plate 44 of the valve assembly 20 is shown as being positioned “below” the seat plate 42. Additionally, in the cross-sectional view of the mesh 50 shown in FIG. 4, the perforated sheet 53 is depicted as being positioned “below” the “lower” layer of reinforcing mesh 51 and the “upper” layer of reinforcing mesh 51 is depicted as being positioned “above” each of the layer of control mesh 52, the “lower” layer of reinforcing mesh 51, and the perforated sheet 53. However, it should be understood that such descriptions are for reference only based on how the various elements are arranged relative to one another in the figures, and therefore should not be construed as limiting in any way on how the depicted structures or components might actually be oriented during manufacture, assembly, and/or use.

The subject matter disclosed herein is directed to various new and unique mesh valve protection devices that may be placed proximate the inlet of a valve so as to protect the valve from damage that may be caused by liquids and/or solids entrained in a gas stream flowing to the valve. Generally, the disclosed mesh valve protection devices serve to prevent larger sized fluid droplets and/or solid particles from reaching the valve by either preventing the larger sized droplets or particles from traversing the mesh, or by breaking up the larger solid pieces or liquid slugs into smaller particles or droplets that can pass safely through the valve with substantially no damage, or so that such damage may be substantially reduced over valve configurations wherein mesh valve protection devices are not used. Additionally, the mesh valve protection device may also act to reduce the momentum of the liquid droplets and/or solid particles by absorbing their energy when the droplets/particles traverse the mesh. Such an arrangement of positioning any one of the several embodiments of the new and unique mesh valve protection devices disclosed herein proximate the inlet of a valve may therefore minimize, or even substantially eliminate, the chance that the valve may be damaged by liquids and/or solids entrained in the gas stream. Accordingly, compressors or other machines incorporating such mesh valve protection devices may on the one hand require less frequent shutdowns to repair this type of valve damage than might otherwise be the case, or on the other hand the valves may be designed for better overall efficiency than would have been possible without using a mesh valve protection device to ensure a minimum valve reliability.

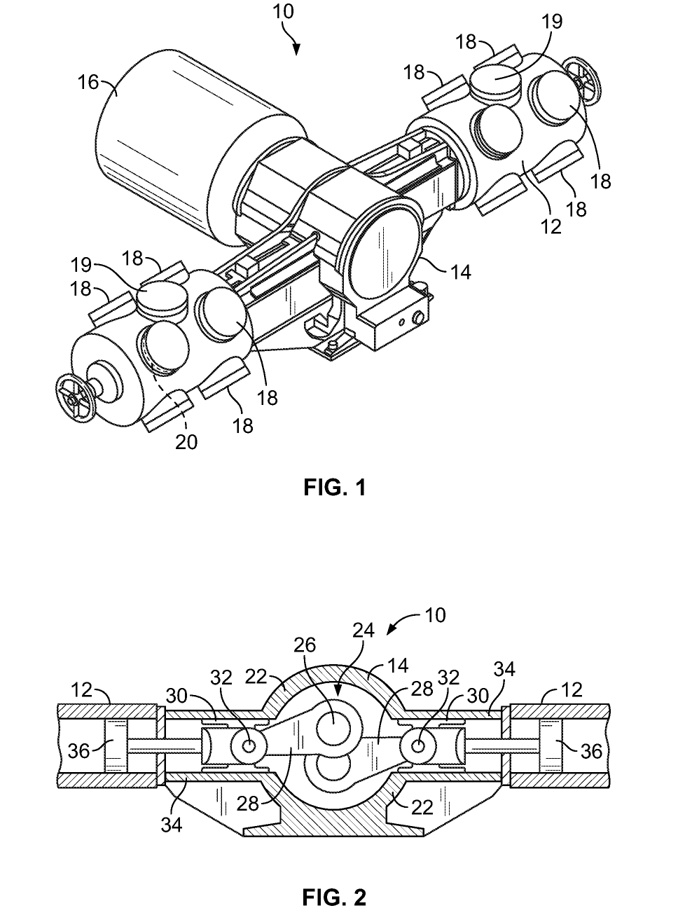

With reference to the figures, a perspective view of an exemplary reciprocating compressor 10 is illustrated in FIG. 1. In the depicted embodiment, the compressor 10 includes a pair of compression cylinders 12 coupled to a frame 14. As discussed in greater detail with respect to FIG. 2 below, a variety of internal components may be disposed within the cylinders 12 and the frame 14 to enable compression of fluids within the cylinders 12. In certain embodiments, the compressor 10 may be used to compress, for example, natural gas, whereas in other embodiments the compressor 10 may be configured and/or adapted to compress other fluids. A mechanical power source or driver 16, such as an engine or an electric motor, may be coupled to the compressor 10 to provide mechanical power to the various internal components and to enable compression of the fluid within the cylinders 12. Additionally, in order to facilitate access to the internal components of the compressor 10 for diagnostic and/or maintenance purposes, openings in the frame 14 may be provided and selectively accessed via removable covers (not shown) disposed over the openings.

In some embodiments, the cylinders 12 may include one or more capped cylinder valve pockets 18 that are adapted to receive suction or discharge valve assemblies, such as a valve assembly 20 (shown schematically only in FIG. 1 by a dashed line; see FIGS. 3 and 5-7 and related description below for additional details). While only a single valve assembly 20 is illustrated and noted in FIG. 1, it should be understood that, in various illustrative embodiments, additional valve assemblies 20 may be included within some or all of the capped cylinder valve pockets 18. It should also be appreciated that the cylinders 12 may include internal fluid conduits between the cylinder valve pockets 18 and the valve assemblies 20 that are adapted to facilitate the flow of a fluid into and out of the cylinders 12 through the valve assemblies 20. For example, with respect to the suction valves of the compressor 10, external suction line piping (not shown) carrying a flow of gas to be compressed would typically be connected to a suction flange 19 (shown as a cover flange in FIG. 1 so as to not obscure the drawing) on the cylinder 12. Typically, the compressor cylinder 12 has a plurality of internal fluid conduits (not shown) that lead from the suction flange 19 to each of the suction valve ports on the cylinder 12. During compressor operation, the gas passing through the suction flange 19 fills the suction valve cylinder pockets 18, and the suction valve assemblies 20 determine when this gas enters the cylinder 12. Under some operational conditions, liquids may condense out of the flow of gas as it flows through the plurality of internal fluid conduits, thus forming droplets or slugs of liquid that eventually must pass through the suction valve assemblies 20. For the particular compressor configuration shown in FIG. 1, external discharge line piping (not shown) would also be connected to a discharge flange (not shown) on the bottom side of the compressor 10, and the cylinder 12 would include similar internal fluid conduits that lead from the discharge valve cylinder pockets 18 to the discharge flange, thus allowing any gas that passes through the discharge valve assemblies 20 in the cylinder 12 to exit the compressor 10 through the discharge flange and the associated discharge line piping.

In certain exemplary embodiments, a valve cage may be used to securely hold a valve assembly 20 in place, such as the valve cage 45 shown in FIGS. 3 and 5-7 and described more fully below. Typically, the valve cage 45 secures a given suction or discharge valve assembly 20 within a respective cylinder valve pocket 18 by the tightening fasteners on respective valve caps (not shown).

Although the exemplary compressor 10 is illustrated as being a two-throw reciprocating compressor, other compressor configurations may also employ and benefit from the systems, apparatuses, and methods disclosed herein. For example, in some embodiments, the compressor 10 may include a different number of cylinder throws, such as a four-throw compressor, a six-throw compressor, or a couple-free reciprocating compressor and the like. Furthermore, other variations to the compressor design/configuration may also be used, including, among other things, variations in the length of stroke, the operating speed, the size, etc. Additionally, the machine in which the valve assembly 20 is employed may be of a different type, such as a screw compressor, a scroll compressor, a refrigeration compressor, a centrifugal compressor, a chiller, a process flow system, a pipeline, an engine, etc.

FIG. 2 is an axial cross-sectional view of the compressor 10 shown in FIG. 1, and illustrates a number of exemplary internal components of the compressor 10. As shown in FIG. 2, the frame 14 of the illustrative compressor 10 includes a hollow central body or housing 22 that generally defines an interior volume 24 in which various internal components may be received, such as a crankshaft 26, connecting rods 28, etc.

In operation, the driver 16 (see, FIG. 1) rotates the crankshaft 26 that is supported within the interior volume 24 of the frame 14. In at least one embodiment, the crankshaft 26 may be coupled to crossheads 30 via connecting rods 28 and pins 32. As shown in FIG. 2, the crossheads 30 may be disposed within crosshead guides 34, which generally extend from the central body 22 and are adapted to facilitate the connection of the cylinders 12 to the compressor 10. In some embodiments, the compressor 10 may include crosshead guides 34 that extend generally perpendicularly from the side of the central body or housing 22, although other configurations may also be used. As may be appreciated by those of ordinary skill, the rotational motion of the crankshaft 26 is translated to a reciprocal linear motion of the crossheads 30 within the crosshead guides 34 via the connecting rods 28.

As noted above, the cylinders 12 are adapted to receive a fluid for compression. The crossheads 32 are coupled to the pistons 36 that are disposed within the respective cylinders 12, and the reciprocating motion of the crossheads allows compression of the fluid within the cylinders 12 by action of the pistons 36. During operation of the compressor 10, as a piston 36 is driven forward (i.e., away from the central body 22) into a respective cylinder 12, the piston 36 forces the fluid within the cylinder into a smaller volume, thereby increasing the pressure of the fluid. A discharge valve (not shown in FIG. 2), which may be a valve assembly 20, may then open to allow the pressurized or compressed fluid to exit the cylinder 12. Thereafter, the piston 36 may stroke backward (i.e., toward the central body 22) and additional fluid may enter the cylinder 12 through an inlet or suction valve, which may also be a valve assembly 20, after which compression of the additional fluid occurs in the same manner described above. As will be appreciated by those of ordinary skill, the cylinders 12 can be configured as double-acting cylinders that facilitate fluid compression on both the forward and the backward strokes of the piston 36. For example, as the piston 36 moves forward (i.e., away from the central body 22) in the manner discussed above so as to compress fluid on one side thereof, additional fluid may be introduced into the cylinder 12 on the opposite side of the piston 36, which in turn would then be compressed on the backward stroke of the piston 36 (i.e., toward the central body 22).

FIG. 3 is a perspective view of an exemplary valve assembly 20 having an integral cage 45. In the depicted embodiment, the valve assembly 20 is configured as a suction valve and includes a seat plate 42 and a retainer plate 44. As shown in FIG. 3, the seat plate 42 may have a number of ports 42p that allow a fluid, such as a gas, to enter and flow through the valve assembly 20, which then leaves the valve assembly 20 through outlet ports (not shown) at the bottom of the retainer plate 44. Positioned within the valve assembly 20, and held in place between the seat plate 42 and the retainer plate 44, are a plurality of dynamic elements (not shown in FIG. 3) that allow the gas to flow only one way through the valve assembly 20. The plurality of dynamic elements open and close the same number of times the piston 36 (see, FIG. 2) moves forwards and backwards, that is at the rpm of the crankshaft 26 (see, FIG. 2), which can be from several hundred to several thousand times per minute. These dynamic elements impact against hard surfaces during every opening and closing event, and accordingly are subject to high stresses. When a slug of liquid and/or a solid particle entrained in the gas stream impacts against these dynamic elements during valve operation, the elements can easily break, thus causing the valve assembly 20 to leak, and thereby adversely affecting the overall performance of the compressor 10. Moreover, a large enough slug of liquid has been known to even break the valve seat plate 42, which is also a very highly stressed structural element.

The valve cage 45 secures the valve assembly 20 within a given cylinder valve pocket 18 (see, FIG. 1) by means of a force that is transmitted through the cage 45 to the valve assembly 20 when fasteners on a cylinder valve cap (not shown) are tightened. The cage 45 typically has large windows 45w around its periphery so as to allow gas from the cylinder flow passage to enter the space within the cage 45, and from there into the valve assembly 20 through the inlet ports 42p of the seat plate 42. The cage 45 may be separately removable from the valve assembly 20, but in the case of an integral cage design, the cage 45 is typically fixedly secured to, or in some cases made integrally with, the valve assembly 20. In the particular embodiment shown in FIG. 3, the cage 45 has a number of columns 45c that are adapted to transmit the force from the cylinder valve cap to the valve assembly 20, and the spaces between the columns 45c function as the windows 45w that allow the gas stream to enter the cage 45 and subsequently flow through the valve assembly 20.

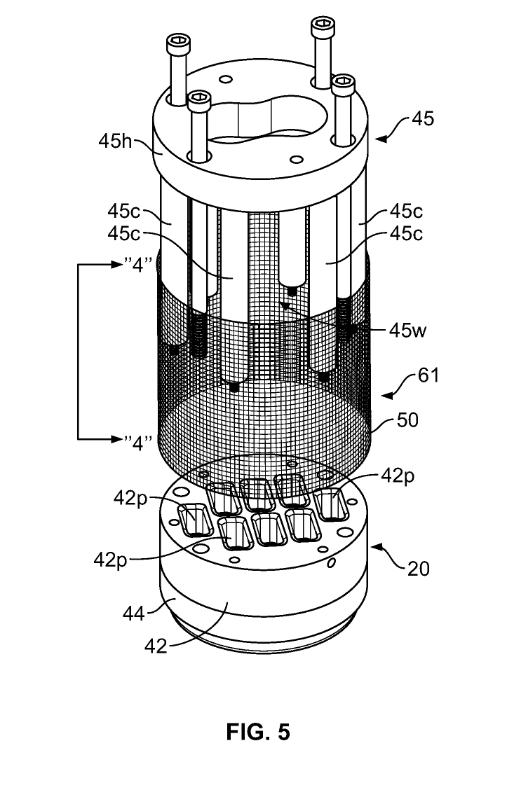

FIG. 4 is a cross-sectional view showing one exemplary embodiment of a mesh 50 when viewed along the section line “4-4” of FIGS. 5-7, which may be used to construct any one or more of the various mesh valve protection devices disclosed herein that are adapted to protect a valve from damage by liquids or solids entrained in a gas stream, such as the illustrative mesh valve protection devices 61, 71, and/or 81 depicted in FIGS. 5-7 and discussed in further detail below. In certain embodiments, the mesh may include one or more layers of material to absorb the impact of slugs/droplets of liquid and/or solid particles in the gas stream, to slow down the slugs/droplets or particles by absorbing their momentum, or to break down the slugs/droplets or particles into smaller, less harmful sizes before entering the valve. In general, the mesh 50 may be constructed so as to control the maximum size of droplets and/or particles that are allowed to pass therethrough, and to have the requisite strength to withstand the maximum anticipated pressure drop across the particular mesh valve protection device. For the embodiment shown in FIG. 4, the mesh 50 may include a first layer of a control mesh 52 having a mesh size that prevents particles of a predetermined certain size from passing through the mesh 50. Additionally, the mesh 50 may also include two layers of reinforcing mesh 51 that sandwich the layer of control mesh 52 on either side so as to reinforce the layer of control mesh 52 and generally protect it from damage. In various embodiments, the reinforcing mesh 51 may be coarser than the control mesh 52. As is shown in the particular embodiment depicted in FIG. 4, the mesh 50 may also include a perforated sheet 53 that is adapted to reinforce the particular mesh valve protection device (see e.g., FIGS. 5-7) so as to prevent it from collapsing under high energy impacts from liquid droplets and/or solids particles, or a pressure drop across the mesh 50.

In one particular embodiment, the control mesh 52 may have a mesh size in the range of about 400 to 18 that is adapted to prevent particles ranging in size from about 0.037-1.0 mm from passing through the mesh 50. Typically, the reinforcing mesh 51 will be a coarser mesh size than the control mesh 52, such as a mesh size in the range of approximately 50 to 4. However, it should be understood that these mesh sizes are exemplary only, and therefore may vary depending on the design and/or operating parameters of the particular application. In certain other embodiments, the perforated sheet 53 may include circular perforations having a diameter of approximately 3-4 mm and a center-to-center spacing of approximately 5-6 mm, and the thickness of the perforated sheet 53 may be in the range of about 0.25-1.0 mm. In some aspects, the perforations in the perforated sheet 53 may be on a substantially square pitch, or on a substantially triangular/staggered pitch. However, it should again be understood that perforation shapes other than circular (e.g., rectangular, square, triangular, etc.) may be used, and the perforation size/spacing and the sheet thickness may also vary based on the specific application.

While the above-noted description of the mesh 50 is illustrative of the particular embodiment depicted in FIG. 4, it will be appreciated by those of ordinary skill in art after a complete reading of the present disclosure that other mesh configurations may also be used, depending on the particular application. Specifically, while the mesh 50 may typically be made up of multiple layers of mesh and/or perforated sheets, the total number of layers can vary from application to application. For example, while the mesh 50 shown in FIG. 4 includes one layer of control mesh 52 sandwiched between two layers of reinforcing mesh 51, at least some embodiments may utilize two or more layers of control mesh 52. Additionally, while in certain embodiments the two layers of reinforcing mesh 51 may have the same mesh size, in other embodiments each layer of reinforcing mesh 51 may have a different mesh size. Similarly, when two or more layers of control mesh 52 are used, some or all may be of the same mesh size, or each may be of a different mesh size. In further exemplary embodiments, there may be only one layer of reinforcing mesh 51 on one side of the layer of control mesh 52 (or multiple layers of control mesh 52). In still other embodiments, the reinforcing mesh 51 and/or the perforated sheet 53 may be completely eliminated from the mesh 50, depending on the strength or rigidity of the layer (or layers) of control mesh 52. In still further configurations, the mesh 50 may use two or more perforated sheets 53 to sandwich the layer (or layers) of control mesh 52, in which case each perforated sheet 53 may be configured the same (e.g., thickness and perforation shape, size, and spacing), or each may be configured differently. Moreover, it should be appreciated that in at least some illustrative embodiments, the mesh 50 may only include a single layer of control mesh 52 with no layers of reinforcing mesh 51 and no perforated sheets 53, provided of course that such a single layer of control mesh 52 can be configured to properly handle the anticipated operating parameters of a given valve.

Typically, the material(s) of the mesh 50 may be chosen based on the various design and operating parameters of the particular application, such as gas composition and temperature, flow velocities, maximum pressure drop across the mesh 50, and the like. For example, in the case of natural gas applications, the mesh material(s) may be any one of several suitable metals, which may typically include one or more grades of stainless steel. For other applications, the mesh 50 may be made from any suitable metallic and/or non-metallic material(s), such as mesh layers of plastic, fiber, or metal, and/or perforated sheets of material such as cloth, metal, etc., or a combination of any of these materials. The different layers of mesh/perforated sheets may be held together by any one or more suitable methods known in the art. For example, in some embodiments, metal mesh layers may be welded together, brazed, or sintered. In other embodiments, different mesh layers may be glued together using suitable adhesives, or they may be mechanically secured to each other in any appropriate manner, such as through the use of clips, tie wires, banding, etc., or by crimping, weaving, or bending one or more of the various material layers.

FIGS. 5-7 illustrate some exemplary configurations of a mesh valve protection device that may be used to reduce, or substantially prevent, damage to a valve assembly that may be caused by liquids and/or solid that are entrained in a gas stream flowing through the valve. In particular, FIG. 5 is an exploded perspective view depicting one exemplary embodiment of a mesh valve protection device 61 in which the mesh 50 is formed into a shape that is substantially that of a cylinder, and used to protect an illustrative valve assembly that is configured in a similar manner to the integral cage valve assembly shown in FIG. 3 and described above. As illustrated in FIG. 3, the cylindrically shaped mesh valve protection device 61 is positioned around the outside of the integral cage 45 of the valve assembly 20 such that it completely encircles cage 45, thus spanning the windows 45w between each adjacent column 45c. In one embodiment, the cylindrically shaped mesh valve protection device 61 may be positioned outside of the integral cage 45 where it may be reinforced and secured in position radially by the columns 45c of the integral cage 45, and where it may also be maintained in position axially by the geometry of the overall valve/cage assembly, e.g., by the seat plate 42 at the bottom and by the cage head 45h at the top.

In other embodiments that are not specifically illustrated, the mesh valve protection device 61 may be positioned within the columns 45c of the cage 45 and secured/reinforced therein by any suitable means, such as machined receiving lips on the seat plate 42 and/or the cage head 45, fasteners, or some other removable means (not shown). In the embodiment depicted in FIG. 5, the cage 45 acts to reinforce the mesh 50 of the mesh valve protection device 61, thus providing it with additional support so as to prevent it from collapsing during operation. Additionally, positioning the mesh valve protection device 61 such that it completely encircles the cage 45 and extends across each of the windows 45w ensures that the gas stream first passes through the mesh 50 of the cylindrically shaped mesh valve protection device 61 substantially without any bypass before entering the valve assembly 20 through the inlet ports 42p. When positioned in this way, the mesh valve protection device 61 may thus substantially prevent large particles and/or slugs of liquid from flowing unhindered through the valve assembly 20. Additionally, as should be appreciated by a person of ordinary skill after a complete reading of the present disclosure, if the valve assembly 20 is non-circular or the valve cage 45 is non-circular, the mesh valve protection device 61 may be non-cylindrical, and instead may be of an appropriate shape that conforms to the windows 45w in the cage 45 such that all fluid flow that goes through the valve assembly 20 must first pass through the mesh valve protection device 61.

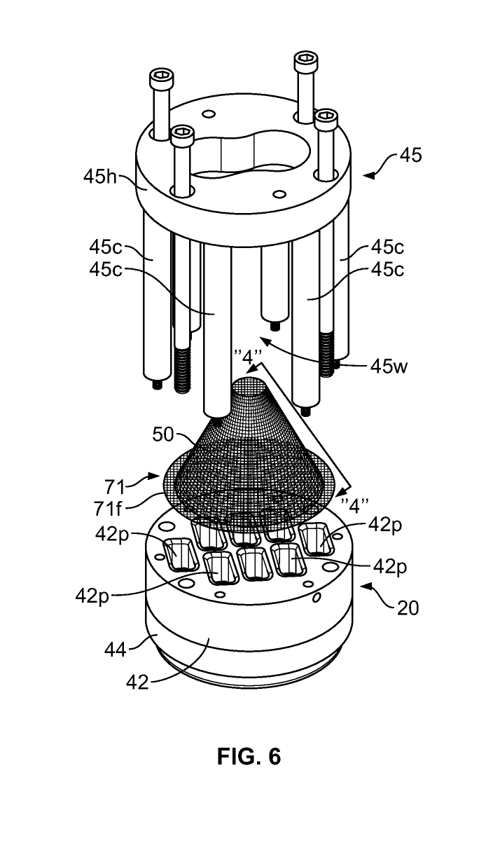

FIG. 6 is an exploded perspective view of the exemplary integral caged valve assembly shown in FIG. 3 and depicts another illustrative mesh valve protection device 71 in accordance with further exemplary embodiments of the present disclosure. As shown in FIG. 6, the mesh 50 is formed into a shape that is substantially that of a truncated cone. When assembled together with the integral cage 45 and the valve assembly 20, the base of the cone is placed proximate to the seat plate 42 of the valve assembly 20, such that at least the truncated cone shaped portion of the mesh valve protection device 71 is positioned fully within the cage 45 and completely covers all the inlet ports 42p. The mesh valve protection device 71 may be removably secured to the valve assembly 20 and/or cage 45 by any one or combination of securing means, including tabs that extend from the sides of the cage 45 (e.g., the columns 45c in the case of the embodiment shown in FIG. 6), a stay or fastener that extends downward from the cage head 45h, ties that extend to one or more of the columns 45c, etc. In a typical embodiment, the base of the cone may be sized to cover or encompass all of the inlet ports 42p, and so that the mesh valve protection device 71 is radially constrained by the inside dimensions of the cage 45.

In certain embodiments, the mesh valve protection device 71 may include a flanged lip 71f that extends from the base of the cone as shown in FIG. 6, and which may be used to secure the mesh valve protection device 71 to the upper surface of the seat plate 42 using any suitable fastening means, such as by the use of screws and/or a circular or segmented clamping ring (not shown). In other embodiments, the outside diameter of the flanged lip 71f may be sized to be substantially the same as the outside diameter of the seat plate 42 so that the columns 42c of the integral cage 45 may be used to secure the mesh valve protection device 71 in place when the cage 45 is fastened to the valve assembly 20. However, it should be understood that the flanged lip 71F depicted in FIG. 6 may not be necessary to the proper function and operation of the mesh valve protection device 71.

Unlike the cylindrically shaped mesh valve protection device 61 shown in FIG. 5, in the embodiment depicted in FIG. 6, the integral cage 45 does not reinforce or support the mesh 50. Instead, the conically shaped mesh valve protection device 71 is designed to be self-supporting. However, while the conical shape of the mesh valve protection device provides an inherently stiffer design, there may be applications that require the use of additional layers of reinforcing mesh 51, control mesh 52, and/or perforated sheets 53. See FIG. 4 and the associated description above. Furthermore, since at least the conically shaped portion of the mesh valve protection device 71 is positioned fully within the integral cage 45, the base of the truncated cone (and/or the flanged lip 71f, when used) are typically sized to fully encompass all of the inlet ports 42p in the seat plate 42, thus ensuring that the gas entering the cage 45 through the windows 45w passes through the mesh 50 of the mesh valve protection device 71 and substantially without any bypass before it enters the valve assembly 20 through the ports 42p.

As noted previously, the illustrative mesh valve protection device 71 shown in FIG. 6 is depicted as having a shape that is substantially that of a truncated cone. In such embodiments, the outer surface of the truncated cone may be substantially defined by a surface of revolution that is generated by rotating an angled line about a central axis. However, in other embodiments, the shape of the mesh valve protection device 71 may be substantially that of a faceted truncated cone, wherein the number of faceted sides of the faceted truncated cone may be determined by the number and/or positioning of inlet ports 42p in the seat plate 42. For example, the faceted truncated cone may have a plurality of sides at the base, e.g., three, four, five, six, or even more, thus forming respective truncated triangular pyramid shapes, truncated rectangular pyramid shapes, truncated pentagonal pyramid shapes, truncated hexagonal pyramid shapes, and the like. Furthermore, it should be understood by those of ordinary skill after a complete reading of the present disclosure that the base of such faceted truncated cones may be designed as a regular geometric shape having equal length sides, or the base may be designed as an irregular geometric shape having unequal length sides, depending on the particular layout of the inlet ports 42p.

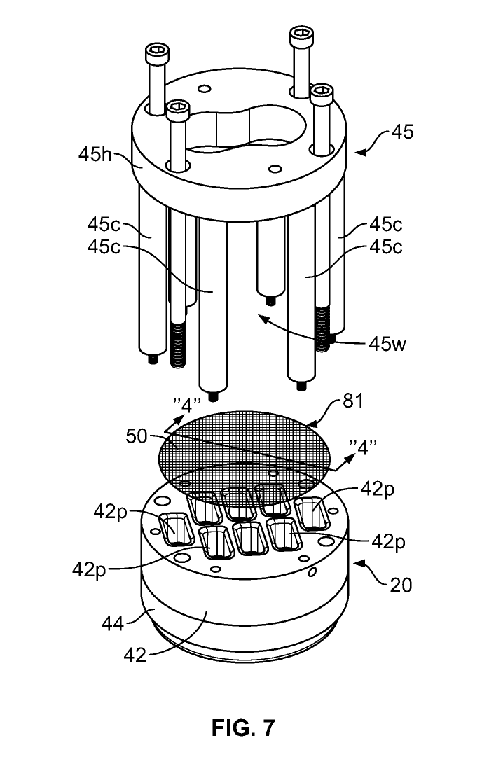

FIG. 7 is an exploded perspective view of the exemplary integral caged valve assembly shown in FIG. 3 and illustrates another illustrative mesh valve protection device 81 that is formed having a shape that substantially conforms to the shape of the upper surface of the seat plate 42, and more specifically, the device 81 is a substantially flat shape that is arranged substantially parallel to the upper surface of the seat plate 42. While the mesh 50 of the mesh valve protection device 81 is depicted in FIG. 7 as being formed into the shape of a substantially flat circular disc, it should be appreciated by those of ordinary skill after a complete reading of the present disclosure that substantially any shape may be used for the device 81, provided that the selected shape is designed to cover and/or encompass each of the inlet ports 42 and to substantially conform to the shape of the upper surface of the seat plate 42, thus enabling the device 81 to serve its intended function of protecting the valve assembly 20 from a fluid flow having entrained liquid and/or solids, as described above.

For example, in embodiments wherein the upper surface of the seat plate 42 is flat, the mesh valve protection device 81 may be any substantially flat shape having an irregularly shaped perimeter that allows the device to be properly retained within the cage 45 (when used) while still fully covering each of the inlet ports 42p in the seat plate 42. Furthermore, in embodiments wherein the upper surface of the seat plate 42 is not flat, such as a curved concave or convex surface, the mesh valve protection device 81 may have a shape that substantially conforms to the curved shape of the upper surface of the seat plate 42. In such embodiments, the radius of curvature of the bottom surface of the mesh valve protection device 81 may be substantially the same as the radius of curvature of the curved upper surface of the seat plate 42, or it may have a radius of curvature that is slightly offset from that of the curved upper surface of the seat plate 42, e.g., by approximately 1 mm or less. Additionally, the perimeter of such curved mesh valve protection devices 81 may have a substantially circular shape, e.g., so that it fits within and is maintained in place by the cage 45 (when used), or it may have any suitable irregular shape that allows it to fully cover all of the inlet ports 42p.

As noted previously, when assembled together with the integral cage 45 and the valve assembly 20, the flat mesh valve protection device 81 shown in FIG. 7 is placed proximate to the seat plate 42 such that it is oriented substantially parallel to the upper surface of the seat plate 42. In certain embodiments, the mesh valve protection device 81 may be secured within the valve cage 45 and/or to the upper surface of the seat plate 42 in any suitable manner, such as is described above with respect to the conically shaped mesh valve protection device 71 depicted in FIG. 6. For example, in certain embodiments, the outer perimeter of the mesh valve protection device 81 may be sized such that it is radially constrained by the inside dimensions of the cage 45. In other exemplary embodiments, the outer perimeter of the mesh valve protection device 81 may extend substantially to the outside diameter of the seat plate 42 so that the columns 42c of the integral cage 45 may be used to secure the mesh valve protection device 81 in place over the seat plate 42 when the cage 45 is fastened to the valve assembly 20.

In the embodiment shown in FIG. 7, the mesh valve protection device 81 may be substantially supported/reinforced by the upper surface of the seat plate 42. Furthermore, in order to ensure that the gas entering the cage 45 through the windows 45w passes through the mesh 50 of the flat mesh valve protection device 81 substantially without any bypass before it enters the valve assembly 20 through the inlet ports 42p, the mesh valve protection device 81 is typically sized to at least encompass all of the inlet ports 42p in the seat plate 42.

As noted previously, the mesh valve protection devices shown in FIGS. 5-7 are exemplary only, and therefore do not represent the only configurations and shapes that fall within the scope of the disclosed subject matter. More specifically, it should be understood by persons of ordinary skill after a complete reading of present disclosure that shapes other than the specifically depicted cylindrical, truncated conical, and flat circular discs may also be used for any mesh valve protection device disclosed herein, provided that mesh valve protection devices employing such other shapes are sized and positioned so as to ensure that a gas stream passes through the mesh valve protection device prior to entering the valve. For example, while not illustrated or expressly described herein in any detail, a mesh valve protection device having a substantially hemispherical shape can be readily envisioned by the ordinarily skilled artisan in light of the subject matter disclosed herein. Furthermore, while each of the particular embodiments depicted in FIGS. 5-7 are shown as being used in conjunction with an integral caged valve assembly, the mesh valve protection devices disclosed herein are not so limited, as they may be used to protect any other type of valve, such as valves assembled to devices without a cage, including valves used in pipelines, engines, and/or other types of equipment. Therefore, it should be understood that the particular embodiments shown in FIGS. 5-7 are not limiting in any way on the scope of the present disclosure, except as might be explicitly indicated in the appended claims.

As a result, the subject matter disclosed herein provides certain aspects of various valve protection devices that may be used to protect a valve from damage caused by liquids and/or solids that are entrained in a gas stream flowing to the valve.

The particular embodiments disclosed above are illustrative only, as the subject matter defined by the appended claims may be modified and practiced in different but equivalent manners apparent to those skilled in the art having the benefit of the teachings herein. For example, some or all of the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the claimed subject matter. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed:

1. A mesh valve protection device comprising at least one layer of mesh, wherein said mesh valve protection device is adapted to be positioned proximate an inlet of a valve assembly so that a fluid flow controlled by said valve assembly passes through said at least one layer of mesh of said mesh valve protection device before passing through said valve assembly.

2. The mesh valve protection device of claim 1, wherein said at least one layer of mesh comprises at least one layer of control mesh that is adapted to control a maximum size of a particle that can pass through said mesh valve protection device.

3. The mesh valve protection device of claim 2, wherein said at least one layer of mesh further comprises at least one layer of reinforcing mesh that is adapted to reinforce said at least one layer of control mesh, wherein a mesh size of said at least one layer of reinforcing mesh is coarser than a mesh size of said at least one layer of control mesh.

4. The mesh valve protection device of claim 1, further comprising at least one perforated sheet that is adapted to reinforce said mesh valve protection device.

5. The mesh valve protection device of claim 1, wherein said mesh valve protection device is adapted to be secured to a seat plate of said valve assembly.

6. The mesh valve protection device of claim 1, wherein said mesh valve protection device has a shape that is adapted to substantially conform to a shape of an upper surface of said seat plate of said valve assembly.

7. The mesh valve protection device of claim 6, wherein said upper surface of said seat plate has a substantially flat shape and said mesh valve protection device has a substantially flat shape that is adapted to be oriented substantially parallel to said upper surface of said seat plate.

8. The mesh valve protection device of claim 1, wherein a shape of at least a portion of said mesh valve protection device substantially conforms to the shape of at least one of a portion of a cone, a portion of a faceted cone having a plurality of sides, a portion of a sphere, and a portion of a cylinder.

9. The mesh valve protection device of claim 8, wherein said mesh valve protection device is adapted to be secured to a valve cage of said valve assembly.

10. The mesh valve protection device of claim 1, wherein said mesh valve protection device is adapted to perform at least one of preventing solid particles in said fluid flow from passing through said valve assembly, reducing a size of said solids particles prior to allowing said reduced size particles to pass through said valve assembly, and reducing a size of liquid slugs in said fluid flow prior to allowing said reduced size liquid slugs to pass through said valve assembly.

11. A valve assembly, comprising:
a valve; and
a mesh valve protection device comprising at least one layer of mesh, wherein said mesh valve protection device is positioned proximate an inlet of said valve so that a fluid flow controlled by said valve passes through said at least one layer of mesh before passing through said valve.

12. The valve assembly of claim 11, wherein said valve comprises a seat plate, said mesh valve protection device being adapted to cover all flow inlet ports in said seat plate.

13. The valve assembly of claim 12, wherein said mesh valve protection device has a shape that is adapted to substantially conform to a shape of an upper surface of said seat plate.

14. The valve assembly of claim 13, wherein said mesh valve protection device has a substantially flat shape that is adapted to be oriented substantially parallel to said upper surface of said seat plate.

15. The valve assembly of claim 11, wherein a shape of at least a portion of said mesh valve protection device substantially conforms to the shape of at least one of a portion of a cone, a portion of a faceted cone having a plurality of sides, a portion of a sphere, and a portion of a cylinder.

16. The valve assembly of claim 15, further comprising a valve cage attached to said valve, wherein said mesh valve protection device is secured to said valve cage.

17. The valve assembly of claim 11, wherein said mesh valve protection device is adapted to perform at least one of preventing solid particles in said fluid flow from passing through said valve assembly, reducing a size of said solids particles prior to allowing said reduced size particles to pass through said valve assembly, and reducing a size of liquid slugs in said fluid flow prior to allowing said reduced size liquid slugs to pass through said valve.

18. A method of protecting a valve assembly during operation, the method comprising:
providing a valve assembly;
positioning a mesh valve protection device proximate an inlet of said valve assembly, said mesh valve protection device comprising at least one layer of mesh; and
controlling a fluid flow with said valve assembly, wherein said fluid flow passes through said at least one layer of mesh of said mesh valve protection device prior to flowing through said valve assembly.

19. The method of claim 18, wherein positioning said mesh valve protection device proximate said inlet of said valve assembly comprises locating said mesh valve protection device over a seat plate of said valve assembly.

20. The method of claim 19, wherein positioning said mesh valve protection device over said seat plate comprises covering all fluid inlet ports in said seat plate with said mesh valve protection device.

21. The method of claim 18, wherein positioning said mesh valve protection device proximate said inlet of said valve assembly comprises securing said mesh valve protection device to a valve cage of said valve assembly.
